(19) United States
(12) Patent Application Publication
(10) Pub. No.: US 2008/0289539 A1
(43) Pub. Date: Nov. 27, 2008

(54) COATING COMPOSITIONS HAVING HYPERBRANCHED POLYMERS AND METHODS OF PRODUCING SAME

(75) Inventor: CHARLES L. TAZZIA, Grosse Pointe Farms, MI (US)

Correspondence Address: BASF CORPORATION;Patent Department, 1609 BIDDLE AVENUE, MAIN BUILDING, WYANDOTTE, MI, 48192, US

(73) Assignee: BASF CORPORATION, SOUTHFIELD, MI (US)

(21) Appl. No.: 11/753,592

(22) Filed: May 25, 2007

(51) Int. Cl. C08G 18/72

(52) U.S. Cl. 106/287.25

(57) ABSTRACT

Coating compositions include a crosslinker and a hyperbranched polymer and methods of producing coating compositions include combining a crosslinker and a hyperbranched polymer. Branching portions of the hyperbranched polymer include a linkage via a carbonyl group and at least two linkages via methylene groups. Branching compounds used in a process to form a hyperbranched polymer include at least one hydroxyl group and at least two oxirane groups. Resulting hyperbranched polymers can include dendrimers. Coating compositions having hyperbranched polymers and crosslinkers can be applied to a substrate and cured to form a crosslinked film.

### BACKGROUND

Hyperbranched polymers represent a class of polymers having additional features compared to linear and crosslinked linear polymers. Hyperbranched polymers are characterized by a large number of chain ends terminating from branching units that may emanate from a core structure. Synthesis of hyperbranched polymers may include reaction of the core with a branching unit followed by subsequent reaction of the terminal sites of the branching units, optionally to derivatize the terminal sites or to add additional branching functionality. Cores may range from those having a single branching site (i.e., monovalent) to multiple branching sites (i.e., polyvalent), or where the core itself is a branched polymer that is extended by another generation of branching units

Batch and step-wise synthetic routes may be used to produce hyperbranched polymers. However, step-wise routes may be performed according to an iterative process to synthesize successive generations of branching, using the same or different branching units in each generation. These methods may be used generate different degrees of random or ordered hyperbranched polymers. In some cases, hyperbranched polymers may be synthesized where intramolecular crosslinking is greatly reduced or prevented; assuring continued and ordered branching of the polymer.

Divergent synthesis of hyperbranched polymers from a monovalent core can be used to produce hyperbranched polymers, while use of a polyvalent core can produce multiple hyperbranched polymer portions radiating from a common core, which collectively is known as a dendritic polymer or dendrimer. Other terms used to describe various dendritic polymers include arborol, cascade, cauliflower, and star polymers. In some cases, hyperbranched polymers may form dendritic segments. These multiple hyperbranched polymers, or dendritic segments, may be coupled to a common core in order to convergently form a dendrimer.

Hyperbranched polymers and dendrimers exhibit unique characteristics in comparison to other polymers. These characteristics include controlled macromolecular dimensions, as relatively discrete populations of molecules may be synthesized by an iterative sequence of steps, and accordingly, substantially uniform molecular weights can be achieved. Furthermore, in some instances, hyperbranched polymers may be more soluble than linear polymers because of their high surface functionality, and, moreover, they lack the chain entanglement of linear polymers resulting in relatively low viscosities. The ability to generate polymers with low viscosities can afford particular advantages in coating compositions. For example, using hyperbranched polymers and/or dendrimers may reduce the overall amount of solvent necessary in the coating composition and may provide unique curing and rheological properties in comparison to coatings made with traditional linear polymers.

Various coating compositions include hyperbranched polymers and/or dendrimers. For example, U.S. Pat. No. 7,144,966 to Ramesh describes acrylic compositions that have highly-branched, star acrylic polymers; U.S. Pat. No. 7,005,473 to Ramesh et al. describes polymeric pigment dispersants of polyester polycarbamate including a highly-branched organic structure; U.S. Pat. No. 6,646,049 to Ramesh describes high-solids thermoset binders formed using hyperbranched polyols as reactive intermediates; and U.S. Pat. No. 6,569,956 to Ramesh describes a hyperbranched polyol macromolecule and coating compositions.

A need, therefore, exists for coating compositions containing hyperbranched polymers and/or dendrimers. Hyperbranched polymers with different chemical linkages and functional groups would increase the diversity of coating compositions, available crosslinking agents, and compatible solvents. Moreover, different branching units and structural geometries can modify steric crowding of branches, affecting the attainable molecular weight and viscosity properties of the resultant hyperbranched polymers and dendrimers. Increases in molecular weight without significant increases in viscosity, or even decreases in viscosity, would reduce the solvent component of a coating composition, and in some instances may permit reduction of volatile organic compounds.

### SUMMARY

The present invention provides coating compositions and methods of producing thermosetting coating compositions that include a crosslinker and a hyperbranched polymer. In some embodiments, a coating composition includes a crosslinker and a hyperbranched polymer, where the hyperbranched polymer comprises at least one crosslinkable group, a first portion, a number of second portions, and a number of branching portions. The first portion includes a radical valency of X, wherein X is a positive integer. Each of the second portions includes a monovalent radical, wherein the number of second portions is at least 2X. Each of the branching portions connects a first and a second portion, wherein the number of branching portions is X. Each branching portion includes a carbonyl radical bonded to the radical of the first portion and at least two methylene radicals, each bonded to the radical of one of the second portions.

In a further embodiment of the hyperbranched polymer, the radical of the first portion is an amine radical and forms an amide bond with the carbonyl radical of the branching portion. The monovalent radical of each second portion may comprise an amine radical that forms a carbon-nitrogen bond with one of the methylene radicals of the branching portion. The monovalent radical of each second portion may also comprise an ester radical that forms an ester bond with one of the methylene radicals of the branching portion. In certain embodiments, the first portion may be a dendrimer core and/or the second portion may be a terminal group of the hyperbranched polymer.

In various embodiments, methods of producing a coating composition include combining a crosslinker having functionality reactive with a hyperbranched polymer and the hyperbranched polymer. The hyperbranched polymer may be formed by a process including reaction of a first compound and a branching compound, wherein the first compound includes at least one isocyanate group, and the branching compound includes at least one hydroxyl group and at least two oxirane groups, to form a furcated compound having at least two oxirane groups. The furcated compound is reacted with at least two second compounds, wherein each second compound includes at least one group reactive with an oxirane group, thereby forming the hyperbranched polymer.

Further embodiments of forming a hyperbranched polymer include where the first compound comprises from 1 to about 6 groups reactive with a hydroxyl group, and in some cases a group of the first compound reactive with a hydroxyl group may be an isocyanate group. The first compound may also be a polyisocyanate or an oligomeric polyisocyanate such as a polyisocyanurate The branched compound may include one hydroxyl group and two oxirane groups, and in some embodiments may be glycerol 1,3-diglycidyl ether. Groups reactive with an oxirane group in the second compound may include a secondary amine or carboxylic acid. Various embodiments include methods where the first compound is a dendrimer core.

Embodiments of compositions and methods of the present invention may include one or more crosslinkers selected from a group consisting of blocked polyisocyanate compounds, uretdione compounds, unblocked polyisocyanates, oligomers thereof, and combinations of these.

The present invention affords various benefits over conventional coating compositions. Such benefits include the ability to incorporate amine-epoxy chemistry in coating compositions with hyperbranched polymers or dendrimers. For example, embodiments of the present invention that use branching compounds with oxirane groups allow reaction with any epoxy-reactive group, such as an amine or carboxylic acid, so that hyperbranched polymers and dendrimers can be extended with additional branching units, capped with conventional epoxy-based reactants, and crosslinked with conventional crosslinkers, including various polyisocyanates and polyisocyanurates. Moreover, the present invention provides coating compositions and methods of producing coating compositions that may be terminated with amines, which may be salted and readily dispersed in water to make aqueous coating compositions, and which may be used as an electrodepositable coating composition.

The present compositions and methods include hyperbranched polymers and/or dendrimers that have high molecular weight but low viscosity due to their generally globular structures. Such properties reduce the tendency of coating films prepared with the composition to pull away from edges of coated substrates during cure. For example, the high molecular weight hyperbranched polymers may reduce the tendency of the film to shrink during cure, while the low viscosity and advantageous Theological properties provide improved leveling and smoothness without use of excessive organic solvent.

These benefits are unexpected improvements over conventional coatings, including electrodepositable coatings. For example, convention coatings may require partially crosslinked polymers to increase molecular weight of the resin. In addition, conventional coatings can produce poor appearance, including films exhibiting an orange peel appearance due to poor flow characteristics, unless corrected with addition of organic cosolvents.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. In addition, disclosure of ranges includes disclosure of all values and further divided ranges within the entire range.

### DETAILED DESCRIPTION

Further areas of applicability and advantages will become apparent from the following description. It should be understood that the description and specific examples, while exemplifying various embodiments of the invention, are intended for purposes of illustration and are not intended to limit the scope of the invention.

As used herein, a hyperbranched polymer includes random hyperbranched polymers as well as hyperbranched polymers with controlled branching Random branching can be produced using one-pot or batch reaction of multifunctional branched compounds, and in some cases, may also result in intramolecular crosslinking. Controlled branching can occur where multifunctional compounds are used in sequential multi-step or iterative syntheses to impart particular directionality in the resulting product. Controlled branching can also prevent or substantially limit intramolecular crosslinking. In some cases, a hyperbranched polymer may be a dendritic segment, where the origin of one or more branching generations may be subsequently joined to a dendrimer core. As a result, a hyperbranched polymer may be part of a larger dendrimer, or multiple dendritic segments may be joined to a single core in order to form a dendrimer. Thus, instances of hyperbranched polymer should be understood to also embody part of a dendrimer, where possible.

Dendrimers can be synthesized by two approaches: a convergent method where growth begins at the chain ends (i.e., termini) and proceeds inward with the final reaction being attachment of several dendritic segments to a central polyfunctional core molecule; and a divergent method where growth begins with a central core and proceeds outward with an ever increasing number of branching reactions required for generation growth. The hyperbranched polymers described herein may be formed by or used in these two approaches.

The present invention includes coating compositions having a hyperbranched polymer, methods of producing these coating compositions, and methods of coating substrates with these coating compositions. Embodiments of coating compositions include a hyperbranched polymer and a crosslinker for the hyperbranched polymer. The hyperbranched polymer comprises at least one crosslinkable group; a first portion including a radical valency of X, wherein X is a positive integer; a number of second portions, each including a monovalent radical, wherein the number of second portions is at least 2X; and a number of branching portions connecting the first and second portions, wherein the number of branching portions is X. Each branching portion includes a carbonyl radical bonded to the radical of the first portion, and at least two methylene radicals, each bonded to the radical of one of the second portions.

The hyperbranched polymer includes at least one crosslinkable group that reacts under cure conditions. The crosslinkable group may include a group reactive with a crosslinker, a self-condensing group, an addition polymerizable group, or a group curable with actinic radiation. Exemplary functional groups include without limitation: isocyanate, blocked isocyanate, uretdione, epoxide, hydroxyl, carboxyl, ester, ether, carbamate, aminoalkanol, aminoalkylether, amide, aminoalkyl ethers, or amine groups. The reaction of the crosslinkable group may produce various cured polymeric films on coated substrates. Cure conditions are selected according to the particular crosslinkable groups in the coating composition to form a cured coating film on the substrate. Embodiments also include hyperbranched polymers with combinations of different crosslinkable groups and further include where the crosslinkable group is located on the first portion, the branching portion, or the second portion of the hyperbranched polymer.

In some embodiments, the first, second, and branching portions of the hyperbranched polymer in the coating composition include particular chemical moieties. With regard to the first portion, the radical of the first portion may be an amine radical and form an amide bond with the carbonyl radical of the branching portion. For example, the connection between the first portion and the branching portion may be the reaction product between a compound having an isocyanate group and a compound having a hydroxyl group, respectively. With regard to the second portion, the monovalent radical of each second portion may include an amine radical and form a carbon-nitrogen bond with one of the methylene radicals of the branching portion. Alternatively, the monovalent radical of each second portion may include an ester radical and form an ester bond with one of the methylene radicals of the branching portion. Such connections may be formed by reaction of an oxirane group and a secondary amine thereby forming a carbon-nitrogen bond, reaction of an oxirane group and a carboxylic acid thereby forming an ester bond, reaction of an alcohol with a carboxylic acid to form an ester bond, and reaction of a carboxylic acid and a secondary amine to form an amide bond.

In various embodiments, the portions of the hyperbranched polymer may include particular structures. With regard to the first portion, the value of X may be 3 and the first portion may include a trivalent radical having the structure:

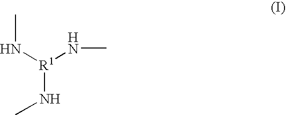

wherein, R¹ represents an organic group that may include alkyl, cycloalkyl, and/or aryl portions. Various embodiments of R¹ may also include heteroatoms. In some embodiments, R¹ may be the residue of a polyisocyanate, such as a triisocyanate or isocyanurate.

In one embodiment the second portion may include a monovalent radical having the structure:

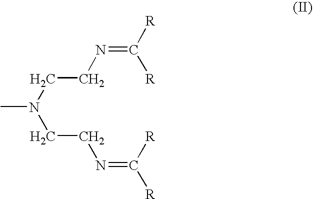

wherein, each R is independently an organic group, such as a lower alkyl group having from 1 to about 6 carbon atoms. For example, each R may be a methyl, ethyl, propyl, butyl, pentyl, or hexyl group, including all isomers of these groups. In some embodiments, each R group can be the same group. In another embodiment, the second portion may include a monovalent radical having the structure:

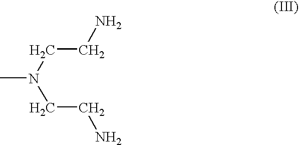

In yet another embodiment, the second portion may include a monovalent radical having the structure:

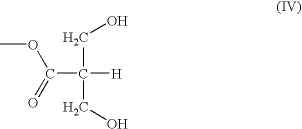

The branching portion may include a trivalent radical having the structure:

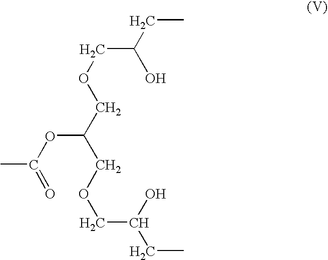

wherein the carbonyl radical is bonded to the first portion and each methylene radical is bonded to one of the second portions.

In various embodiments, the coating composition includes a hyperbranched polymer in which the first portion is a dendrimer core. Embodiments also include those in which the first portion is an interior part of a dendrimer and the second portion is an exterior part of a dendrimer. In some cases, the first portion may be an earlier generation while the second portion is a later generation of a multi-generation dendrimer. Embodiments also include those in where the second portion is a terminal group; for example, a terminal group is an end portion of the hyperbranched polymer that does not further extend or branch.

In some embodiments, the second portions of the hyperbranched polymer may contain various functional groups, including the crosslinkable group Or, the second portions may be derivatized by reaction with a compound to include a functional group or to change or add functionality. The second portion may be a terminal group of the hyperbranched polymer. Thus, the exterior or periphery of the hyperbranched polymer may contain functional groups capable of reacting with one or more crosslinkers in the coating composition. Reaction of the hyperbranched polymer with the crosslinker may chemically bond the hyperbranched polymer to another such molecule, to another crosslinker, or to an additional material selected from monomeric compounds, oligomers, and polymers in the coating composition. Reaction of the hyperbranched polymer or dendrimer and the crosslinker may be used to cure a film of the coating composition applied to a substrate.

Coating compositions of the present invention may contain epoxy, acrylic, polyurethane, polycarbonate, polysiloxane, aminoplast, and/or polyester resins. These various resins can be formed by reactions of monomers having appropriate functional groups, as is known in the art, to produce the corresponding resin bond linkages. Such reactions include the following non-limiting examples: epoxide reacted with carboxylic acid resulting in an ester linkage; epoxide reacted with amine resulting in an amine linkage; hydroxyl reacted with isocyanate resulting in a urethane linkage; hydroxyl reacted with anhydride resulting in an ester linkage; epoxide reacted with hydroxyl resulting in an ether linkage; hydrolysis of alkylsilicon or arylsilicon halides followed by condensation of the silanol to form a siloxane linkage; bisphenol reacted with carbonic acid (including derivatives such as phosgene, urea, carbonates) resulting in an ester linkage; aldehyde reacted with amine followed by condensation between alkylol and amine groups to form an amine linkage; and other types of linkages generally used in forming coating resins.

The present invention also embodies various methods of producing a coating composition that include combining a crosslinker and a hyperbranched polymer. The hyperbranched polymer may be formed by various processes. In one embodiment, the hyperbranched polymer is formed by a process that includes reacting a first compound and a branching compound, wherein the first compound includes at least one isocyanate group and the branching compound includes at least one hydroxyl group and at least two oxirane groups, thereby forming a furcated compound having at least two oxirane groups. The furcated compound is reacted with at least two second compounds, wherein each second compound includes at least one group reactive with an oxirane group, thereby forming the hyperbranched polymer.

The first compound including at least one isocyanate group may be a polyisocyanate or an isocyanurate. In some embodiments, the first compound may include from one to about six isocyanate groups In one embodiment, the first compound includes three isocyanate groups. A convenient source of triisocyanate functional compounds is the known isocyanurate derivative of diisocyanates. Isocyanurate derivatives of diisocyanates can be made by reacting the diisocyanate together with a suitable trimerization catalyst. An isocyanurate derivative is produced that contains an isocyanurate core with pendant organic chains terminated by three isocyanate groups. Exemplary compounds include isocyanurates of isophorone diisocyanate, monomeric or polymeric methylene diphenyl diisocyanate, or hexamethylene diisocyanate. Several isocyanurate derivatives of diisocyanates are commercially available. In some embodiments, the isocyanurate of isophorone diisocyanate and/or the isocyanaurate of hexamethylene diisocyanate is used

In some embodiments, the first compound may be a dendrimer core Reaction of the dendrimer core first compound with the branching compound may produce a furcated compound that is a first generation dendrimer. Reaction of the furcated compound with the second compound may produce the hyperbranched polymer, where the hyperbranched polymer is a second generation dendrimer. In various embodiments, one or more of these reactions may be repeated to produce hyperbranched polymers or dendrimers comprising additional generations.

With respect to the branching compound, in some embodiments the branching compound may include at least one hydroxyl group and two or more oxirane groups. Exemplary branching compounds include hydroxy ethylene glycol diglycidyl ether; hydroxy propylene glycol diglycidyl ether; glycerol-1,3-diglycidyl ether; polyethylene glycol diglycidyl ether; hydroxy 1,6-hexanediol diglycidyl ether; and isomers and combinations thereof.

The reaction between the first compound and the branching compound should be conducted under conditions such that the hydroxyl group of the branching compound preferentially reacts with the isocyanate group in the first compound before the oxirane groups of the branching compound can react with the first compound. The result is a number of new branch sites in the furcated compound corresponding to the number of oxirane groups. For example, the number of branch sites in the furcated compound can then react with the same number of second compounds. Additional rounds of these reactions can produce successive generations in the hyperbranched polymer (or dendrimer), where the number of end groups is exponentially dependent on the number branching functionalities (i.e., the reactive groups) and the generation number. Embodiments of this process, therefore, may provide controlled synthesis of hyperbranched polymers having fairly defined numbers of end groups by using a step-wise or iterative synthesis. Relatively uniform or even discrete molecular species of hyperbranched polymers may be produced in this manner. Conversely, a batch process or random synthesis may be used where the numbers of end groups in the hyperbranched polymer is not important, based on the intended application or molecular weight or range of molecular weights sought.

With respect to the second compound, the group reactive with an oxirane group may be a secondary amine or a carboxylic acid. In some embodiments, the group reactive with an oxirane group may include a salted tertiary amine, for example, a tertiary amine that is reacted with an organic acid. The second compound may further include at least one secondary ketimine group. In embodiments where the second compound includes the secondary ketimine, the secondary ketimine may become part of the hyperbranched polymer upon reaction of the second compound and the furcated compound, and subsequently may be hydrolyzed to form a primary amine group. In one embodiment, the second compound includes two secondary ketimine groups. The resulting amine group, as part of the hyperbranched polymer, may then be reacted with the crosslinker during cure of the coating composition. The amine group may also be reacted with additional compounds, for example, to produce another generation in the hyperbranched polymer or to derivatize the hyperbranched polymer by including another functional group, or alternatively, the amine may be reacted with a portion of another monomer, oligomer, or polymer. In some embodiments, the amine group provides a basic group that may be salted with an acid in making an aqueous coating composition. Salting is generally known as neutralization or acid-salting and specifically refers to the reaction of pendent amino or quarternary groups with an acidic compound in an amount sufficient to neutralize enough of the basic amino groups to impart water-dispersibility to the hyperbranched polymer.

Embodiments also include those in which each second compound has at least one hydroxyl group, which is incorporated into the hyperbranched polymer upon reaction of the second compound and furcated compound. In one embodiment, the second compound includes two hydroxyl groups. Similar to the previously described embodiments having an amine group, embodiments include further reaction of the hyperbranched polymer hydroxyl functionality,. The hydroxyl group may be reacted with the crosslinker during cure of the coating composition; e.g., using an isocyanate-based crosslinker. The hydroxyl group may also be reacted to produce another generation in the hyperbranched polymer or to derivatize the hyperbranched polymer by including another functional group, or alternatively, the hydroxyl may be reacted with a portion of another monomer, oligomer, or polymer.

In various embodiments, coating compositions of the present invention include hyperbranched polymers that are further reacted with a dendrimer core to convergently form a dendrimer. In this manner, one or more hyperbranched polymers are reacted with a dendrimer core to coalesce the hyperbranched polymer(s) about a central core structure. In some embodiments, the dendrimer core is a compound having multiple reactive groups that form covalent bonds with multiple hyperbranched polymers. Embodiments also include where the dendrimer core itself already contains one or more branching generations.

A coating composition including a hyperbranched polymer may be formed by a process where at least one of the second compounds includes a crosslinkable group or a group convertible to a crosslinkable group that is incorporated into the hyperbranched polymer upon reaction of the second compound with the furcated compound. The crosslinkable group or the group convertible to a crosslinkable group may include a functional group other than the amine group and/or hydroxyl group contributed by the second compound as already described.

The crosslinkable group or the group convertible to a crosslinkable group may depend on the choice of one or more crosslinkers and/or additional monomers, oligomers, and polymers present in the coating composition, as the group may be selected to be compatible with these additional components and reactive with the crosslinker. Compatibility may include factors such as the ability to crosslink with these additional components, solubility, and dispersability in the coating composition.

Compositions and methods of the present invention include various crosslinkers. The crosslinker may be selected from a group consisting of blocked polyisocyanate compounds, uretdione compounds, unblocked polyisocyanates, oligomers thereof, and combinations thereof The crosslinker contains at least two functional groups, where at least one functional group is reactive with the crosslinkable group on the hyperbranched polymer. Examples of reactions between the crosslinkable group (and/or additional functional groups within hyperbranched polymer) with the crosslinker include: reaction of an isocyanate with an active hydrogen functional group, such as a hydroxyl or a primary or secondary amine; or reaction between an aminoplast and an active hydrogen material such as a carbamate, urea, amide or hydroxyl group; reaction of an epoxy with an active hydrogen material such as an acid, phenol, or amine; reaction of a cyclic carbonate with an active hydrogen material such as a primary or secondary amine; reaction of a silane (i.e., Si—O—R where R═H, an alkyl or aromatic group, or an ester) with an active hydrogen material, including when the active hydrogen material is Si—OH; or combinations of these reactions.

Examples of suitable crosslinkers include: unblocked and blocked polyisocyanate compounds such as self-blocking uretdione compounds; caprolactam- and oxime-blocked polyisocyanates; isocyanurates of diisocyanates; diisocyanates half-blocked with polyols; and combinations thereof. Polyisocyanate crosslinkers can comprise any desired organic polyisocyanate having free isocyanate groups attached to aliphatic, cycloaliphatic, araliphatic and/or aromatic structures. Polyisocyanates may have from two to five isocyanate groups per molecule. Exemplary isocyanates are described in “Methoden der organischen Chemie” [Methods of Organic Chemistry], Houben-Weyl, volume 14/2, 4th Edition, Georg Thieme Verlag, Stuttgart 1963, pages 61 to 70, and by W. Siefken, Liebigs Ann. Chem. 562, 75 to 136. Suitable examples include 1,2-ethylene diisocyanate, 1,4-tetramethylene diisocyanate, 1,6-hexamethylene diisocyanate, 2,2,4- and 2,4,4-trimethyl-1,6-hexamethylene diisocyanate, 1,12-dodecane diisocyanate, omega,omega′-diisocyanatodipropyl ether, cyclobutane 1,3-diisocyanate, cyclohexane 1,3- and 1,4-diisocyanate, 2,2- and 2,6-diisocyanato-1-methylcyclohexane, 3-isocyanatomethyl-3,5,5-trimethylcyclohexyl isocyanate(isophorone diisocyanate), 2,5- and 3,5-bis(isocyanatomethyl)-8-methyl-1,4-methano-decahydronaphthalene, 1,5-, 2,5-, 1,6- and 2,6-bis(isocyanatomethyl)-4,7-methanohexahydroindane, 1,5-, 2,5-, 1,6- and 2,6-bis(isocyanato)-4,7-methylhexahydroindane, dicyclohexyl 2,4′- and 4,4′-diisocyanate, 2,4- and 2,6-hexahydrotolylene diisocyanate, perhydro 2,4′- and 4,4′-diphenylmethane diisocyanate, omega,omega′-diisocyanato-1,4-diethylbenzene, 1,3- and 1,4-phenylene diisocyanate, 4,4′-diisocyanatobiphenyl, 4,4′-diisocyanato-3,3′-dichlorobiphenyl, 4,4′-diisocyanato-3,3′-dimethoxybiphenyl, 4,4′-diisocyanato-3,3′-dimethylbiphenyl, 4,4′-diisocyanato-3,3′-diphenylbiphenyl, 2,4′- and 4,4′-diisocyanatodiphenylmethane, naphthylene-1,5-diisocyanate, tolylene diisocyanates, such as 2,4- and 2,6-tolylene diisocyanate, N,N′-(4,4′-dimethyl-3,3′-diisocyanatodiphenyl)uretdione, m-xylylene diisocyanate, dicyclohexylmethane diisocyanate, tetramethylxylylene diisocyanate, but also triisocyanates, such as 2,4,4′-triisocyanatodiphenyl ether, 4,4′,4″-triisocyanatotriphenyl methane. Polyisocyanates can also contain isocyanurate groups, biuret groups, allophanate groups, urethane groups, and/or urea groups. Polyisocyanates containing urethane groups, for example, are obtained by reacting some of the isocyanate groups of a polyisocyanate, preferably one isocyanate group of a diisocyanate, with polyols, for example trimethylol propane and glycerol.

Polyisocyanate crosslinkers can further include polymeric MDI, an oligomer of 4,4′-diphenylmethane diisocyanate, or other polyisocyanate that is blocked with an ethylene glycol ether diol or a propylene glycol ether diol. Such crosslinkers containing urethane groups can be prepared, for example, from Lupranate® M20S, or other similar commercially available materials Polyisocyanate compounds are commercially available from, among others, BASF AG, Degussa AG, and Bayer Polymers, LLC.

In various embodiments of producing a coating composition, the hyperbranched polymers of the present invention can be the sole film-forming resin, form a population of resins, or can be combined with additional resins. The hyperbranched polymers can be used as a grind resin, principal resin, and/or as a crosslinker. The same resin can be used in preparing a pigment dispersion and a principal resin, or mixtures of various resins can be used to form a coating composition. In a pigmented composition, the grind resin and the principal resin can be combined in forming a coating composition containing one or more hyperbranched polymers according to the present invention.

In various embodiments, coating compositions can also include a mixture of resin compounds with groups reactive with a crosslinker. The mixture of compounds can include more than one type of resin with groups reactive with a crosslinker, a resin mixture with one or more co-monomers, and more than one resin with at least one co-monomer.

In various embodiments, the coating composition may include one or more polymeric, oligomeric, and/or monomeric materials. The coating composition may include various resins, such as epoxy, acrylic, polyurethane, polycarbonate, polysiloxane, polyvinyl, polyether, aminoplast, and polyester resins, and may include mixtures of such resins. In embodiments where the resin is a polymer, it can be a homopolymer or a copolymer. Copolymers have two or more types of repeating units.

In some embodiments, the present coating compositions may include epoxy oligomers and polymers, such as polymers and oligomers of polyglycidyl ethers of polyhydric phenols such as bisphenol A. These can be produced by etherification of a polyphenol with an epihalohydrin or dihalohydrin such as epichlorohydrin or dichlorohydrin in the presence of alkali. Suitable polyhydric phenols include bis-2,2-(4-hydroxyphenyl)propane, bis-1,1-(4-hydroxyphenyl)ethane, bis(2-hydroxynaphthyl)methane and the like. The polyglycidyl ethers and polyhydric phenols can be condensed together to form the oligomers or polymers. Other useful poly-functional epoxide compounds are those made from novolak resins or similar poly-hydroxyphenol resins. Also suitable are polyglycidyl ethers of polyhydric alcohols such as ethylene glycol, propylene glycol, diethylene glycol and triethylene glycol. Also useful are polyglycidyl esters of polycarboxylic acids which are produced by the reaction of epichlorohydrin or a similar epoxy compound with an aliphatic or aromatic polycarboxylic acid such as succinic acid or terepthalic acid.

In some embodiments, an additional resin includes a liquid epoxy that is the reaction product of diglycidyl ether of bisphenol A and bisphenol A. Examples include modified upgraded epoxy resins having epoxy equivalent weights of approximately 100 to 1200 or more. Suitable liquid epoxies are GY2600, commercially available from Huntsman, and Epon® 828, commercially available from Hexion Specialty Chemicals, Inc. For example, epoxy-containing compounds can be reacted with hydroxyl-containing compounds, such as bisphenol A, ethoxylated bisphenol A, phenol, polyols, or substituted polyols.

Embodiments also include coating compositions having hyperbranched polymers and/or epoxy resins capped with an amine, where “capped” means a functional group on the hyperbranched polymer and/or resin, such as an epoxide group, is reacted with an amine-containing compound to covalently bond the amine compound to the resin. Exemplary capping compounds include ammonia or amines such as dimethylethanolamine, aminomethylpropanol, methylethanolamine, diethanolamine, diethylethanolamine, dimethylaminopropylamine, the diketamine derivative of diethylenetriamine, and mixtures thereof. In various embodiments, for example, a cathodic electrocoating composition may be formed by salting the amine-containing hyperbranched polymer or resin with an acid and dispersing it in water.

It should be noted that in some embodiments, such as for example, liquid epoxy coating compositions, the overall molecular weight of the hyperbranched polymer will affect the liquid phase properties, such as the viscosity of the coating composition. Consequently, the molecular weight (and corresponding viscosity) of the coating composition can be adjusted as required by changing the degree of branching and/or number of generations in the hyperbranched polymer or corresponding dendrimers formed from them.

In some embodiments, the coating composition can comprise a vinyl or acrylic resin, wherein the resin may be reacted with the hyperbranched polymer and/or crosslinker. In some cases, part of the hyperbranched polymer may include one or more vinyl groups. The acrylic polymer includes a functional group which is a hydroxyl, amino, or epoxide group that is reactive with the crosslinker. Ethylenically unsaturated monomers that may be used in forming the acrylic polymer having reactive functionality include esters or nitriles or amides of alpha, beta-ethylenically unsaturated monocarboxylic acids containing from 3 to 5 carbon atoms; vinyl esters, vinyl ethers, vinyl ketones, vinyl amides, and vinyl compounds of aromatics and heterocycles. Representative examples further include acrylic and methacrylic acid amides and aminoalkyl amides; acrylonitrile and methacrylonitriles; esters of acrylic and methacrylic acid, including those with saturated aliphatic and cycloaliphatic alcohols containing 1 to 20 carbon atoms such as methyl, ethyl, propyl, butyl, 2-ethylhexyl, isobutyl, isopropyl, cyclohexyl, tetrahydrofurfuryl, and isobornyl acrylates and methacrylates; esters of fumaric, maleic, and itaconic acids, like maleic acid dimethyl ester and maleic acid monohexyl ester; vinyl acetate, vinyl propionate, vinyl ethyl ether, and vinyl ethyl ketone; styrene, alpha-methyl styrene, vinyl toluene, and 2-vinyl pyrrolidone.

In various embodiments, acrylic polymers can be formed by addition polymerization of monomers such as methyl acrylate, acrylic acid, methacrylic acid, methyl methacrylate, butyl methacrylate, and cyclohexyl methacrylate. The functional group can be incorporated into the ester portion of the acrylic monomer. For example, hydroxyl-functional acrylic copolymers may be formed by polymerization using various hydroxy-functional addition polymerizable monomers, including but not limited to, hydroxyethyl acrylate, hydroxybutyl acrylate, hydroxybutyl methacrylate, or hydroxypropyl acrylate; amino-functional acrylic copolymers may be formed by polymerization with t-butylaminoethyl methacrylate and t-butylaminoethylacrylate; and epoxide-functional acrylic copolymers may be formed by reaction with glycidyl acrylate, glycidyl methacrylate, or allyl glycidyl ether.

Where the hyperbranched polymer contains a vinyl group, it may be polymerized with comonomers in synthesizing the resin. Suitable compounds for incorporation during addition polymerization include the following: 4-allyl-1,2-dimethoxybenzene; 2-allyl-2-methyl-1,3-cyclopentanedione; 2-allyloxytetrahydropyran; allylphenyl carbonate; 3-allylrhodanine; allyltrimethoxysilane; itaconic anhydride; maleic anhydride; and combinations thereof.

Acrylic copolymers may be prepared by using conventional techniques, such as free radical polymerization, cationic polymerization, or anionic polymerization, in, for example, a batch, semi-batch, or continuous feed process. For instance, the polymerization may be carried out by heating the ethylenically unsaturated monomers in bulk or in solution in the presence of a free radical source, such as an organic peroxide or azo compound and, optionally, a chain transfer agent, in a batch or continuous feed reactor. Alternatively, the monomers and initiator(s) may be fed into the heated reactor at a controlled rate in a semi-batch process. Where the reaction is carried out in a solution polymerization process with organic solvent, the solvent can be removed after the polymerization is completed. In some cases, the polymerization may be carried out in the absence of any organic solvent.

Typical free radical sources are organic peroxides such as dialkyl peroxides, peroxyesters, peroxydicarbonates, diacyl peroxides, hydroperoxides, and peroxyketals; and azo compounds such as 2,2′-azobis(2-methylbutanenitrile) and 1,1′-azobis(cyclohexanecarbonitrile). Typical chain transfer agents are mercaptans such as octyl mercaptan, n- or tert-dodecyl mercaptan, thiosalicyclic acid, mercaptoacetic acid, and mercaptoethanol; halogenated compounds, and dimeric alpha-methyl styrene. The free radical polymerization is usually carried out at temperatures from about 20° C. to about 250° C., preferably from 90° C. to 170° C. The reaction is carried out according to conventional methods.

Acrylic resins can have an equivalent weight (grams resin solid per mol equivalent functional group) from about 150 to 950, including about 300 to about 600, and further including about 350 to about 550. The number average molecular weight (Mn) can be from about 2,000 to about 10,000. In some embodiments, the coating compositions including the hyperbranched polymer and acrylic resin can be used to form an electrocoating composition. An acrylic resin suitable for use in a cathodic electrocoating composition may be formed by copolymerizing an amine-functional ethylenically unsaturated monomer. The amine is salted and dispersed in water. An acrylic resin suitable for use in a cathodic electrocoating composition may also be formed by copolymerizing glycidyl methacrylate then reacting a secondary amine, such as methylethanolamine, to create a salting site.

The coating composition may further include a polyester resin and/or one of the components of the hyperbranched polymer may be polyester. Polyfunctional acid or anhydride compounds can be reacted with polyfunctional alcohols to form the polyester, and include aliphatic and aromatic compounds. Typical compounds include dicarboxylic acids and anhydrides of dicarboxylic acids; however, acids or anhydrides with higher functionality may also be used. If tri-functional compounds or compounds of higher functionality are used, these may be used in mixture with mono-functional carboxylic acids or anhydrides of monocarboxylic acids, such as versatic acid and fatty acids. Illustrative examples of acid or anhydride functional compounds suitable for forming the polyester groups or anhydrides of such compounds include phthalic acid, phthalic anhydride, isophthalic acid, terephthalic acid, hexahydrophthalic acid, tetrachlorophthalic anhydride, hexahydrophthalic anhydride, pyromellitic anhydride, succinic acid, azeleic acid, adipic acid, 1,4-cyclohexanedicarboxylic acid, citric acid, and trimellitic anhydride.

The polyol component used to make the polyester has a hydroxyl functionality of at least two. The polyol component may also contain mono-, di-, and tri-functional alcohols, as well as alcohols of higher functionality. Diols are a typical polyol component. Alcohols with higher functionality may be used where some branching of the polyester is desired, and mixtures of diols and triols can be used as the polyol component.

Examples of useful polyols include, but are not limited to, ethylene glycol, diethylene glycol, triethylene glycol, propylene glycol, dipropylene glycol, butylene glycol, glycerine, trimethylolpropane, trimethylolethane, pentaerythritol, neopentyl glycol, 2,2,4-trimethyl-1,3-pentanediol, 1,6-hexanediol, 1,4-cyclohexane dimethanol, hydrogenated bisphenol A, and ethoxylated bisphenols.

Methods of making polyester resins are well-known. Polyesters are typically formed by heating together the polyol and polyfunctional acid components, with or without catalysts, while removing the byproduct water in order to drive the reaction to completion. The polyester synthesis may be carried out under suitable, well-known conditions, for example at temperatures from about 150° C. to about 250° C., with or without catalyst (e.g., dibutyl tin oxide, tin chloride, butyl chlorotin dihydroxide, or tetrabutyoxytitanate), typically with removal of the byproduct water (e.g., by simple distillation, azeotropic distillation, vacuum distillation) to drive the reaction to completion. For example, toluene may be added in order to remove the water azeotropically

The coating composition may include a polyurethane resin and/or part of the hyperbranched polymer may include urethane linkages. Polyurethanes can be formed from two components, where the first includes compounds containing hydroxyl groups (e.g., polyols) and the second component includes at least one polyisocyanate compound. The compounds containing hydroxyl groups may include a polyol component and are at least difunctional for the purposes of the isocyanate-addition reaction. The polyol component generally has an average functionality of about two to eight, preferably about two to four. These compounds may have a molecular weight of from about 60 to about 10,000, preferably from 400 to about 8,000. However, it is also possible to use low molecular weight compounds having molecular weights below 400. The only requirement is that the compounds used should not be volatile under the heating conditions, if any, used to cure the compositions.

Macromonomer compounds containing isocyanate-reactive hydrogen atoms are the known polyester polyols, polyether polyols, polyhydroxy polyacrylates and polycarbonates containing hydroxyl groups. In addition to these polyhydroxy compounds, it is also possible to use polyhydroxy polyacetals, polyhydroxy polyester amides, polythioethers containing terminal hydroxyl groups or sulfhydryl groups or at least difunctional compounds containing amino groups, thiol groups or carboxyl groups. Mixtures of the compounds containing isocyanate-reactive hydrogen atoms may also be used. Other exemplary hydroxyl containing compounds can be found in U.S. Pat. No. 4,439,593 to Kelso et al., issued Mar. 27, 1984, which is hereby incorporated by reference.

Coating compositions of the present invention may also include one or more catalysts. Catalysts for reaction of isocyanate crosslinkers include metals and metal compounds such as dibutyl tin oxide, dibutyl tin dilaurate, zinc oxide, bismuth oxide, tin oxide, yttrium oxide, copper oxide, and combinations thereof. A metal catalyst can be incorporated at various steps in producing the coating composition. In some embodiments, the metal catalyst is incorporated in the step of forming the coating composition, i.e., as the hyperbranched polymer is formed by the various reactions and mixtures described herein. Alternatively, the metal catalyst can be incorporated into the coating composition after the hyperbranched polymer is formed and prior to the reaction of the hyperbranched polymer and the crosslinker to form a cured coating. For instance, in some embodiments, a pigment-containing coating composition, including the hyperbranched polymer, may be incorporated prior to the step of reacting (i.e., curing) the resin and the crosslinker. Coating compositions commonly incorporate such pigment-containing compositions.

Embodiments can include one metal catalyst, or a combination of metal catalysts can be employed. The metal catalysts, such as, for example, various metal oxides, can be supplied in a milled form having a low particle size (e.g., less than 20 microns, more typically less than 10 microns) such that no additional grinding is needed to reduce the particle size of the metal catalyst for effective incorporation into the coating composition.

In various embodiments, methods of producing a coating composition can further comprise forming a salting site (acid or base) on the hyperbranched polymer and/or additional resin(s). For example, the second compound used in the process of forming the hyperbranched polymer may contain a carboxyl group, an amine group, or a ketimine that is hydrolyzable to a primary amine. Or, the hyperbranched polymer may be further reacted with an amine containing compound, such as methylaminoethanol, diethanol amine, or the diketamine derivative of diethylenetriamine, to provide a salting site on the resin for use in cathodic electrocoating. Alternatively, quaternium ammonium, sulfonium, or phosphonium sites can be incorporated. Or, the hyperbranched polymer may be reacted with a compound containing carboxyl or anhydride functionality to provide a salting site for making anionic aqueous coating compositions.

These various salting sites may be neutralized, or salted, in forming an aqueous dispersion to produce electrodepositable or other aqueous coating compositions, for example. The film-forming material may have basic groups salted with an acid for use in a cathodic electrocoating composition. This reaction is termed neutralization or acid-salting and specifically refers to the reaction of pendent amino or quarternary groups with an acidic compound in an amount sufficient to neutralize enough of the basic amino groups to impart water-dispersibility to the resin. Illustrative acid compounds include phosphoric acid, propionic acid, acetic acid, lactic acid, formic acid, sulfamic acid, alkylsulfonic acids, and citric acid. Or, an acidic resin can be salted with a base to make an anodic electrocoating composition. For example, ammonia or amines such as dimethylethanolamine, triethylamine, aminomethylpropanol, methylethanolamine, and diethanolamine can be used to form an anionic coating composition.

Coating compositions may also include at least one additive. Several types of additives are known to be useful in coating compositions. Such additives include various organic solvents, surfactants, dispersants, additives to increase or reduce gloss, pigments, fillers, hindered amine light stabilizers, ultraviolet light absorbers, antioxidants, stabilizers, wetting agents, rheology control agents, and adhesion promoters Such additives are well-known and may be included in amounts typically used for coating compositions.

The hyperbranched polymers can be used to produce aqueous coating compositions. The aqueous medium of a coating composition is generally predominantly water, but a minor amount of organic solvent can be used. Examples of useful organic solvents include, without limitation, ethylene glycol butyl ether, propylene glycol phenyl ether, propylene glycol propyl ether, propylene glycol butyl ether, diethylene glycol butyl ether, dipropylene glycol methyl ether, propylene glycol monomethyl ether acetate, xylene, N-methylpyrrolidone, methyl isobutyl ketone, mineral spirits, butanol, butyl acetate, tributyl phosphate, dibutyl phthalate, and so on. However, organic solvent can be avoided to minimize organic volatile emissions from the coating process.

Examples of suitable surfactants include, without limitation, the dimethylethanolamine salt of dodecylbenzene sulfonic acid, sodium dioctylsulfosuccinate, ethoxylated nonylphenol, sodium dodecylbenzene sulfonate, the Surfynol® series of surfactants (Air Products and Chemicals, Inc.), and Amine-C (Huntsman Corp.). Generally, both ionic and non-ionic surfactants may be used together, and, for example, the amount of surfactant in an electrocoat composition may be from 0 to 2%, based on the total solids. Choice of surfactant can also depend on the coating method. For example, an ionic surfactant should be compatible with the particular electrocoating composition, whether it is cathodic or anodic.

When the coating composition is a primer composition or pigmented topcoat composition, such as a basecoat composition, one or more pigments and fillers may be included. Pigments and fillers may be utilized in amounts typically of up to about 40% by weight, based on total weight of the coating composition. The pigments used may be inorganic pigments, including metal oxides, chromates, molybdates, phosphates, and silicates. Examples of inorganic pigments and fillers that could be employed are titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, calcium carbonate, talc, barytes, ferric ammonium ferrocyanide (Prussian blue), ultramarine, lead chromate, lead molybdate, and flake pigments such as mica and aluminum. Organic pigments may also be used. Examples of useful organic pigments are metallized and non-metallized azo reds, quinacridone reds and violets, perylene reds, copper phthalocyanine blues and greens, carbazole violet, monoarylide and diarylide yellows, benzimidazolone yellows, tolyl orange, naphthol orange, and the like.

The present invention also includes methods of coating substrates by application of coating compositions having hyperbranched polymers and crosslinkers. Coated substrates may have one or more coating layers prepared from the coating compositions described herein, which may also be combined with other coating layers prepared using conventional coating compositions, to form multicoated substrates. As described above, coating compositions of the present invention may further include epoxy, acrylic, polyurethane, polycarbonate, polysiloxane, aminoplast, and/or polyester resins, for example.

Coating compositions formed according to the methods described herein can be coated on a substrate by any of a number of techniques well-known in the art. These include, for example, spray coating, dip coating, electrodeposition, roll coating, curtain coating, knife coating, coil coating, and the like. In some embodiments, the coating composition of the invention can be electrodepositable and can be coated onto the substrate by electrodeposition. The electrodeposited or applied coating layer can be cured on the substrate by reaction of the hyperbranched polymer and crosslinker, and in some embodiments may include reaction of additional resins as described.

Aqueous coating compositions may be electrodeposited as is conventionally performed in the art. Electrodeposition, for example, can include immersing an electrically conductive article in an electrocoating bath containing a coating composition of the present teachings, connecting the article as the cathode or anode, preferably as the cathode, depositing a coating composition film on the article using direct current, removing the coated article from the electrocoating bath, and subjecting the deposited electrocoated material film to conventional thermal curing, such as baking.

Coating compositions of the present invention are also useful as coil coatings Coil coatings are applied to coiled sheet metal stock, such as steel or aluminum, in an economical, high speed process. The coil coating process results in a high quality, uniform coating with little waste of the coating and little generation of organic emissions as compared to other coating methods, e.g. spray application.

Coil coating is a continuous feeding operation, with the end of one coil typically being joined (e.g., stapled) to the beginning of another coil. The coil is first fed into an accumulator tower and coating is fed into an exit accumulator tower, with the accumulator towers allowing the coating operation to continue at constant speed even when intake of the coil is delayed. For example, coil advancement can be delayed to start a new roll, or for winding of the steel, for example, to cut the steel to end one roll and begin a new roll. The coil is generally cleaned to remove oil or debris, pre-treated, primed with a primer on both sides, baked to cure the primer, quenched to cool the metal, and then coated on at least one side with a topcoat. A separate backer or a different topcoat may be applied on the other side. The topcoat is baked and quenched, then fed into the exit accumulator tower and from there is re-rolled.

The coating compositions can be applied onto many different substrates, including metal substrates such as bare steel, phosphated steel, galvanized steel, gold, or aluminum; and non-metallic substrates, such as plastics and composites including an electrically conductive organic layer. In electrocoating (e.g., electrodeposition) or electrospray, only electrically conductive substrates are used. The substrate may also be any of these materials having upon it already a layer of another coating, such as a layer of an electrodeposited primer, primer surfacer, and/or basecoat, either cured or uncured.

Although various methods of curing may be used, in some embodiments, thermal curing can be used for reacting the hyperbranched polymer and the crosslinker. Thermal curing may include reaction of the various functional group pairings described above in reference to the crosslinker. Generally, thermal curing is effected by heating at a temperature and for a length of time sufficient to cause the reactants (i.e., the hyperbranched polymer and crosslinker) to form an insoluble polymeric network. The cure temperature can be from about 150° C. to about 200° C. for electrocoating compositions, and the length of cure can be about 15 minutes to about 60 minutes. Cure temperatures can be lower, for example, and in some embodiments can be reduced to 140° C. when metal catalysts are included in the coating composition. Therefore, lower bake temperatures can be used in some instances. For topcoats, the cure temperature can be from about 120° C. to about 140° C. and the cure time can be about 15 minutes to about 30 minutes. Heating can be done in infrared and/or convection ovens.

A coil coating composition cures at a given peak metal temperature. The peak metal temperature can be reached more quickly if the oven temperature is high. Oven temperatures for coil coating generally range from about 220° C. to about 500° C., to obtain peak metal temperatures of between 180° C. and about 250° C., for dwell times generally ranging from about 15 seconds to about 80 seconds. Oven temperatures, peak metal temperature and dwell times are adjusted according to the coating composition, substrate, and level of cure desired. Examples of coil coating methods are disclosed in U.S. Pat. Nos. 6,897,265; 5,380,816; 4,968,775; and 4,734,467, which are incorporated herein by reference.

The present technology is further described in the following examples. The examples are merely illustrative and do not in any way limit the scope of the technology as described and claimed.

### EXAMPLE 1

### Synthesis of a Furcated Compound from a Trivalent Core

An exemplary hyperbranched polymer according to the present invention is formed by reacting a first compound and a branching compound to form a furcated compound. The furcated compound is further reacted with a second compound to form the hyperbranched polymer. The hyperbranched polymer is combined with a crosslinker to form a coating composition.

To synthesize a furcated compound, an isocyanate compound, here having three free isocyanate groups, is reacted with glycerol 1,3-diglycidyl ether. The synthesis scheme is illustrated as follows:

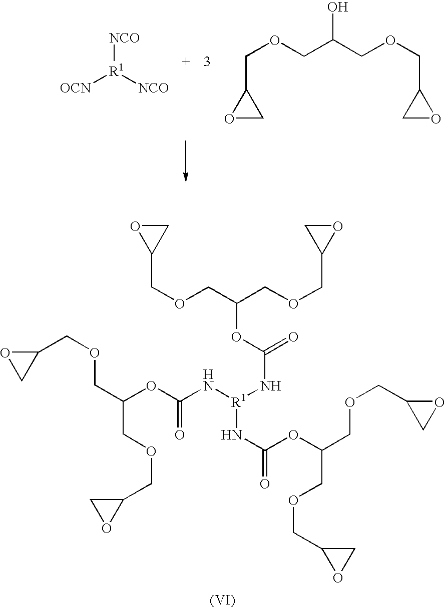

The isocyanate compound includes isocyanate groups that preferentially react with the hydroxyl group of glycerol 1,3-diglycidyl ether to form a furcated compound (VI). As shown above, the isocyanate compound in this case is a triisocyanate, which functions as a trivalent core for addition of the three branching compounds, which are glycerol 1,3-diglycidyl ether molecules. The triisocyanate may be any organic compound having three isocyanate groups capable of reacting with the hydroxyl group of the glycerol 1,3-diglycidyl ether. Thus, R¹ represents a trivalent organic radical that may include alkyl, cycloalkyl, and/or aryl portions, and may also include heteroatoms.

The furcated compound (VI) contains six oxirane groups capable of reacting with up to six second compounds to form a hyperbranched polymer.

### EXAMPLE 2

### Synthesis of an Amine-Terminal Hyperbranched Polymer

An amine-terminal hyperbranched polymer is synthesized by reacting the furcated compound (VI) from Example 1 with the second compound (VII) shown below. The synthesis scheme is illustrated as follows:

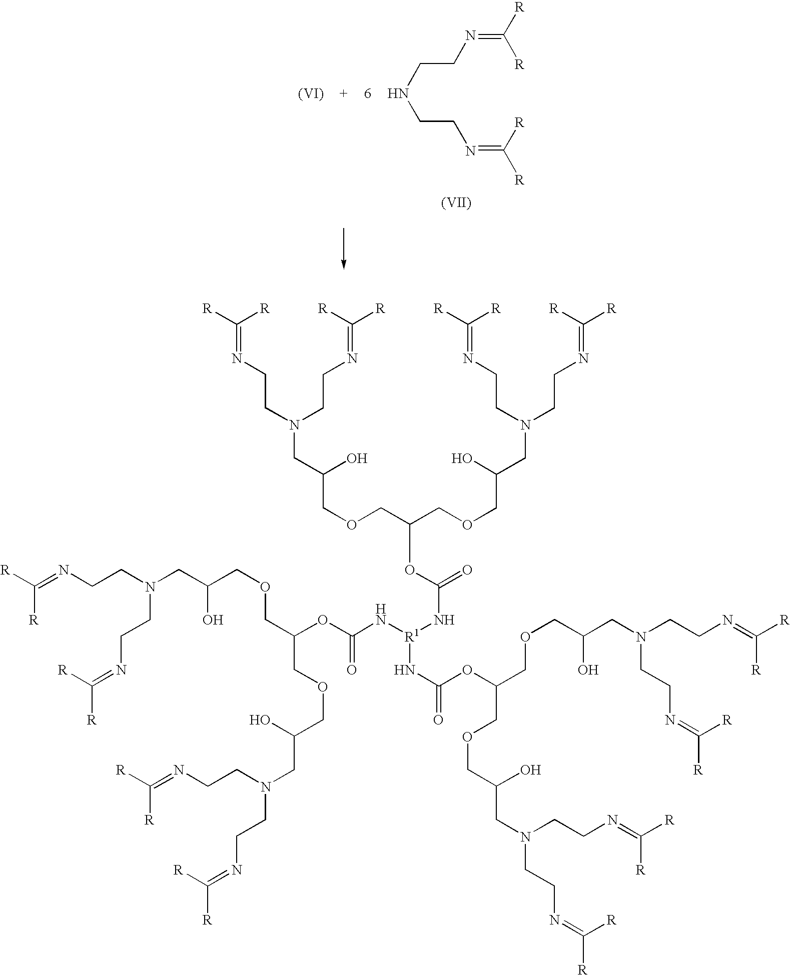

The six oxirane groups of the furcated compound (VI) preferentially react with the secondary amine groups of the six second compounds (VII). Each exemplary second compound shown above contains two ketimine groups, each bonded to an organic group, R. In this case, each R is independently any organic group, such as a lower alkyl group having from one to about six carbon atoms, where each R group may also be identical.

The reaction between the furcated compound (VI) and the second compound (VII) results in the hyperbranched polymer shown above, which is also an embodiment of a dendrimer. The twelve ketimine groups in the hyperbranched polymer are hydrolyzed under acidic conditions to form twelve primary amines (not shown). The hyperbranched polymer with the twelve terminal primary amine groups is used in a coating composition, or the primary amine groups are further reacted with additional compounds or salted, for example. Alternatively, the hyperbranched polymer is not hydrolyzed and the twelve ketimine groups may be derivatized or further extended.

### EXAMPLE 3

### Synthesis of a Hydroxy-Terminal Hyperbranched Polymer

A hydroxy-terminal hyperbranched polymer is synthesized by reacting the furcated compound (VI) from Example 1 with 3-hydroxy-2-(hydroxymethyl)propanoic acid as shown below. The synthesis scheme is illustrated as follows:

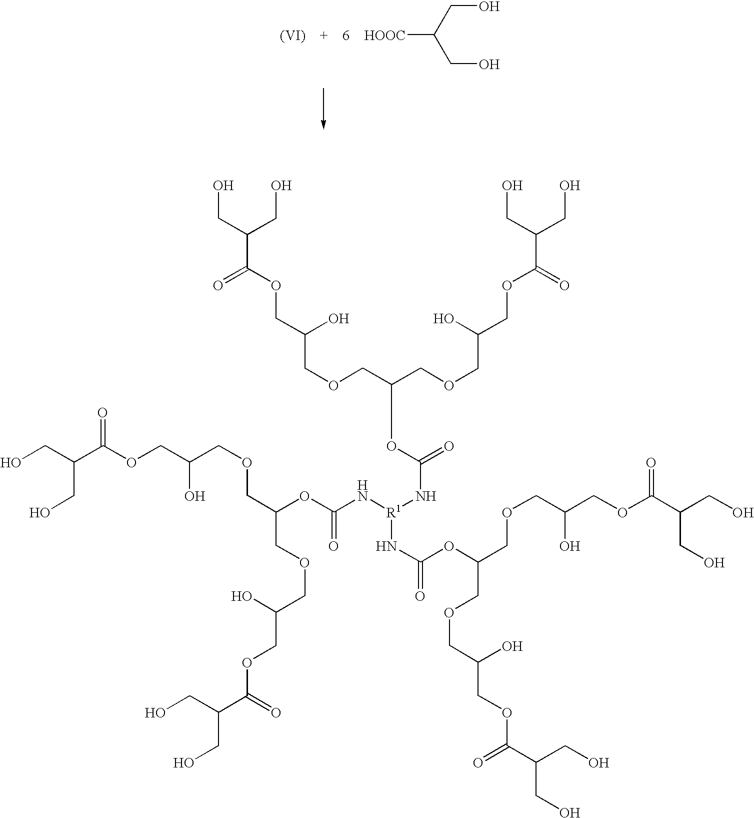

The six oxirane groups of the furcated compound (VI) preferentially react with the carboxylic acid groups of the six 3-hydroxy-2-(hydroxymethyl)propanoic acid compounds. Each 3-hydroxy-2-(hydroxymethyl)propanoic acid compound shown above contributes two hydroxyl groups to the resultant hyperbranched polymer. The hyperbranched polymer shown is also an embodiment of a dendrimer. The hyperbranched polymer with the twelve terminal hydroxyl groups is used in a coating composition. Alternatively, the hydroxyl groups are further reacted with additional compounds to further derivatize the hyperbranched polymer or to produce another branching generation on the dendrimer.

The description of the technology is merely exemplary in nature and, thus, variations that do not depart from the gist of the present invention are intended to be within the scope of the invention. Such variations are not to be regarded as a departure from the spirit and scope of the invention.

What is claimed is:

1. A curable coating composition comprising:
a crosslinker; and
a hyperbranched polymer, wherein the hyperbranched polymer comprises:
at least one crosslinkable group that reacts under cure conditions;
a first portion having a radical valency of X, wherein X is a positive integer;
a number of second portions, each including a monovalent radical,
wherein the number of second portions is at least 2X; and
a plurality of branching portions connecting said first and second portions,
wherein the number of branching portions is X, each branching portion including:
a carbonyl radical bonded to the radical of said first portion, and
at least two methylene radicals, each bonded to the radical of one of said second portions.

2. A coating composition of claim 1, wherein the radical of said first portion is an amine radical and forms an amide bond with the carbonyl radical of said branching portion.

3. A coating composition of claim 1, wherein the monovalent radical of each second portion comprises an amine radical and forms a carbon-nitrogen bond with one of the methylene radicals of said branching portion.

4. A coating composition of claim 1, wherein the monovalent radical of each second portion comprises an ester radical and forms an ester bond with one of the methylene radicals of said branching portion.

5. A coating composition of claim 1, wherein the branching portion comprises a trivalent radical having the structure: 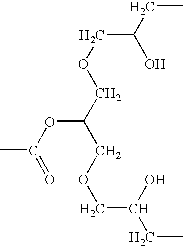
wherein, the carbonyl radical is bonded to said first portion and each methylene radical is bonded to one of said second portions.

6. A coating composition of claim 1, wherein X is 3 and the first portion comprises a trivalent radical having the structure: 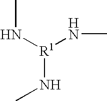
wherein, R¹ comprises a trivalent organic group.

7. A coating composition of claim 1, wherein the second portion comprises a monovalent radical having the structure: 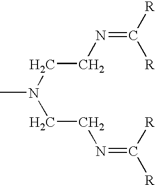
wherein, each R is independently an organic group having from 1 to about 6 carbon atoms.

8. A coating composition of claim 1, wherein the second portion comprises a monovalent radical having the structure:

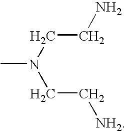

9. A coating composition of claim 1, wherein the second portion comprises a monovalent radical having the structure:

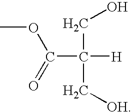

10. A coating composition of claim 1, wherein the crosslinkable group is part of the second portion of the hyperbranched polymer.

11. A coating composition of claim 1, wherein the crosslinkable group is a group reactive with a crosslinker, a self-condensing group, an addition polymerizable group, or a group curable with actinic radiation.

12. A coating composition of claim 1, wherein the first portion is a dendrimer core.

13. A coating composition of claim 1, wherein the second portion is a terminal group.

14. A coating composition of claim 1, wherein the crosslinker is selected from the group consisting of blocked polyisocyanate compounds, uretdione compounds, unblocked polyisocyanates, oligomers thereof, and combinations thereof.

15. A method of producing a coating composition comprising:
combining a crosslinker and a hyperbranched polymer in a coating composition,
wherein the hyperbranched polymer is formed by a process comprising:
reacting a first compound and a branching compound, wherein the first compound includes at least one isocyanate group and the branching compound includes at least one hydroxyl group and at least two oxirane groups, thereby forming a furcated compound having at least two oxirane groups; and
reacting the furcated compound with at least two second compounds, wherein each second compound includes at least one group reactive with an oxirane group, thereby forming the hyperbranched polymer.

16. A method of claim 15, wherein the first compound includes three isocyanate groups.

17. A method of claim 15, wherein the first compound is a polyisocyanate or a polyisocyanurate.

18. A method of claim 15, wherein the first compound is selected from the group consisting of an isocyanurate of isophorone diisocyanate and an isocyanaurate of hexamethylene diisocyanate.

19. A method of claim 15, wherein the branching compound comprises one hydroxyl group and two oxirane groups.

20. A method of claim 15, wherein the branching compound is selected from the group consisting of hydroxy ethylene glycol diglycidyl ether; hydroxy propylene glycol diglycidyl ether; glycerol 1,3-diglycidyl ether; polyethylene glycol diglycidyl ether; hydroxy 1,6-hexanediol diglycidyl ether; and isomers and combinations thereof.

21. A method of claim 15, wherein the group reactive with an oxirane group is a secondary amine, a carboxylic acid, or a salted tertiary amine.

22. A method of claim 15, wherein each second compound further includes at least one secondary ketimine group.

23. A method of claim 22, further comprising:
hydrolyzing the secondary ketimine group of the hyperbranched polymer to form a primary amine group.

24. A method of claim 15, wherein each second compound further includes at least one hydroxyl group.

25. A method of claim 15, wherein the first compound is a dendrimer core.

26. A method of claim 15, further comprising:
reacting the hyperbranched polymer with a dendrimer core to convergently form a dendrimer.

27. A method of claim 15, wherein the crosslinker is selected from the group consisting of blocked polyisocyanate compounds, uretdione compounds, unblocked polyisocyanates, oligomers thereof, and combinations thereof.

28. A method of claim 15, wherein at least one of the second compounds includes a crosslinkable group or a group convertible to a crosslinkable group that is incorporated into the hyperbranched polymer upon reaction with the furcated compound.
